(19) United States
(12) Patent Application Publication
(10) Pub. No.: US 2013/0014057 A1
(43) Pub. Date: Jan. 10, 2013

(54) COMPOSITE CONTROL FOR A GRAPHICAL USER INTERFACE

(75) Inventors: Michael A. Reinpoldt, Windermere, FL (US); Willem H. Reinpoldt, III, Tarpon Springs, FL (US)

(73) Assignee: THERMAL MATRIX USA, INC., Tampa, FL (US)

(21) Appl. No.: 13/177,625

(22) Filed: Jul. 7, 2011

(51) Int. Cl. G06F 3/048

(52) U.S. Cl. 715/833

(57) ABSTRACT

A system and method for manipulating computer data using a new GUI element is disclosed. In a particular embodiment, the new GUI element is a composite of a traditional GUI button control and a traditional GUI slider control. In one embodiment, a composite slidable button control appears and functions similar to a traditional button control on the GUI. Dragging the composite control past its predetermined anchor distance un-anchors the composite control allowing it to travel similar to a traditional slider control, optionally constrained in direction(s) and distance(s) by predetermined settings. During the slider adjustment phase, the composite control can optionally overlap other GUI elements realizing a more compact and efficient GUI appearance. In another embodiment, a composite clickable slider control appears and functions similar to a traditional slider control on the GUI. Clicking on the composite control's slider handle invokes the button functionality while dragging the handle invokes the slider functionality, again affording the composite control the ability to function as both a button and a slider control.

### I. FIELD

The present invention relates in general to graphical user interfaces, and in particular to a system and method of implementing a composite control for a graphical user interface.

### II. DESCRIPTION OF RELATED ART

Graphical user interfaces (GUIs) have become a standard method of interfacing to computer systems. GUIs are traditionally comprised of various elements such as buttons, slider controls, checkboxes, icons, windows, pull-down menus and the like. These elements greatly simplify user interface to computers compared to text based interfaces, allowing actions to be performed through direct manipulation of the graphical elements.

Buttons and slider controls are frequently used interface elements, allowing either discrete on-off control of a software value in the case of buttons, or continuous adjustment control of a software value in the case of sliders. However, no adequate method has been provided for employing the functionality of both button and slider controls in a single graphical user interface element.

Accordingly, there is a need in the relevant art for a system and method that gives the user the ability to manipulate a single GUI element in both a discrete button-like and continuous slider-like fashion.

There is also a need in the art for a system and method that combines the functionality of a button and a slider while maintaining the appearance of a button, thus masking the appearance and complexity of the control until its functionality is required by the user.

Another need exists in the art for a system and method that automatically returns the combined button and slider control to its original location and appearance on the GUI after usage by the operator.

Another need exists in the art for a system and method that implements the combined functionality of the button- and slider controls in an intuitive and integrated fashion.

However, in view of the prior art at the time the present invention was made, it was not obvious to those of ordinary skill in the pertinent art how the identified needs could be fulfilled.

### III. SUMMARY

In a particular embodiment, a method is disclosed for a composite GUI control element that has the appearance and functionality of a button element, but also the functionality of a slider element. The method allows the composite control to function as a conventional button element, including clicking to activate the control in a momentary fashion, active only while clicked, or in another embodiment, the composite control can function in a toggle fashion, active once clicked or otherwise invoked and remaining active until clicked or otherwise invoked again. The method allows the composite control to function as a conventional slider element if the composite control is dragged sufficiently by the operator. In this case, the button becomes unanchored and free to move along a predetermined slider track or slide area, optionally having the slider track or slide area displayed. In this embodiment, the composite control can be referred to as a slidable button.

The method further includes the ability for appearance of the composite control to morph from a button element to a slider element once the composite control has been dragged sufficiently by the operator to un-anchor the control.

The method further includes the ability to click and/or drag the composite control element using a keyboard, mouse, light pen, track ball, track pad, joy stick, graphics tablet, touch screen, or other GUI pointing device. The term “click” is used to denote selecting the control with a discrete action of the GUI pointing device, as a conventional GUI button element is typically invoked. This action typically involves pressing and releasing a button on the GUI pointing device. The term “drag” is used to denote adjusting a value with a continuous action of the GUI pointing device, as a GUI slider control element is typically invoked. This action typically involves pressing and holding a button, then moving the GUI pointing device without releasing the button.

In another particular embodiment, the appearance of the composite control element may change shape, color, appearance, text, transparency and background, or any combination thereof, optionally in response to the dragging procedure.

In another particular embodiment, after the composite control element has been dragged sufficiently to break its anchored location, the composite control element will be constrained in one or more predetermined directions.

In another particular embodiment, after the composite control element has been dragged sufficiently to break its anchored location, the slider nature will be constrained to move to maximum predetermined directions.

In another particular embodiment, after the composite control element has been dragged sufficiently to break its anchored location, the slider nature will be constrained to move within a predetermined slide area.

In another particular embodiment, after the composite control element has been dragged and the GUI pointing device button is released so as to end the drag operation, software will read and retain the final position and/or value of the slider control and the composite control will return to its original (pre-drag) location and appearance.

In another particular embodiment, a system of a morphing composite control includes a button element displayed on a visual display at a first location, where the button control is configured to morph to a slider control with a slider adapted to slide along a slider track in response to a pointing device providing directional instructions to the button element. The system also includes a button element that morphs from the slider control to the button element in response to the pointing device releasing the slider control.

In another particular embodiment, another method for implementing and manipulating the combined functionality of a button control and a slider control is disclosed. The method includes provision for a composite control that initially has a slider-like appearance but that also has the functionality of a button when its handle is clicked; in this embodiment the composite control can be referred to as a clickable slider. The method further includes the ability for the composite clickable slider control to support having its handle clicked like a typical button control, and react in a conventional button-like behavior.

The method further includes the ability for the composite clickable slider control to optionally remain resistant to moving via the drag technique until sufficient drag distance has been reached, at which time the control will become un-anchored and thus behave like a slider control. The term “un-anchored” refers to the composite control no longer remaining in the same location but following the GUI pointing device as it moves, similar to an icon or slider control following the GUI pointing device as it is dragged across the display.

In another particular embodiment, after the composite clickable slider control has been clicked without being dragged sufficiently to break its anchored location, the appearance of the composite control may change to be more indicative of its new button-like function including, but not limited to, shape, color, appearance (optionally including 3-dimensional indentation) text, transparency and background. This would also make it possible for the initial appearance of the composite control to be replaced with a disparate slider and/or slider handle appearance.

In another particular embodiment, a non-transitory processor readable medium includes processor instructions that are executable to cause a processor to display a button element on a visual display at a first location. The processor includes instructions to cause the processor to optionally morph the button element into a slider control in response to a pointing device providing directional instructions to the button element where the slider control includes a slider configured to slide along a slider track. The instructions further cause the processor to display the slider at a desired location on the slider track in response to the pointing device. The instructions may cause the processor to morph the slider control back into the button element in response to the pointing device releasing the slider control.

One particular advantage provided by the embodiments is that the functionality of a discrete button and a continuously variable slider are combined into a single GUI element, thereby simplifying the appearance of the GUI and simplifying the operator's interface with the computer, resulting in more streamlined and simplified operation thus promoting greater retention of the operation of the GUI and decreased training costs for the operators.

Another particular advantage provided by the embodiments is that the combined functionality of a button element and a slider element into a single GUI element is that the GUI requires less display real estate, allowing either a simplified appearance for the GUI or increased use of the GUI display for additional functionality.

Another particular advantage provided by the embodiments is that for a particular case where the continuously variable requirement of the control is required less frequently than the discrete on/off requirement, the continuously variable nature of the control is effectively hidden from the operator and the GUI, streamlining the operator interface.

Another particular advantage provided by the embodiments is that the button element can be spaced closely with other elements on the GUI, for example as close as traditional buttons can be placed. Once a particular control is then dragged sufficiently to un-anchor it, it will then slide over any adjacent GUI elements, overlapping any other controls for as long as the selected control is active. This capability greatly economizes the utilization of real estate on the GUI and allows for significantly higher density of slider controls that populate the GUI than traditional sliders would allow.

Another particular advantage provided by the embodiments is the efficiency of operation and simplicity of operation provided by combining the functions of a button and a slider. In one embodiment, the composite slidable button's primary function may enable or disable a feature in the software while the secondary slider function adjusts the magnitude or value of the feature in the software. In another embodiment, the composite clickable slider's primary function may adjust the magnitude of a value or the balance of values (such as an audible volume or fader control), while the secondary button function enables or disables the feature (such as mute or equalize).

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular embodiment of a method of combining the functionalities of a button element and a slider element;

FIG. 2 is a diagram of a particular illustrative embodiment of a GUI incorporating the invention and showing the idle, non-manipulated state of the composite element;

FIG. 3 is a diagram of a particular illustrative embodiment of a GUI incorporating the invention and showing on operator activating the composite element;

FIG. 4 is a diagram of a particular illustrative embodiment of a GUI incorporating the invention and showing the active, un-anchored state of the composite control;

FIG. 5 is a diagram of a particular illustrative embodiment of a GUI incorporating the invention and showing the active, un-anchored state of the composite control in its horizontal clickable-slider configuration and being dragged; and

FIG. 6 is a diagram of a particular illustrative embodiment of a GUI incorporating the invention and showing the active, un-anchored state of the button element and returning to its original position.

### V. DETAILED DESCRIPTION

The method and system disclosed herein is a new composite control for a graphical user interface (“GUI”), including two traditional GUI elements, namely a button control (or button element) and a slider control (or slider element). In its normal state, the composite slidable-button control appears and functions as a button. The slidable-button control can function as a momentary control, active only as it is clicked or otherwise invoked. In another embodiment, the slidable-button control can function as a toggle on/off control, active once clicked or otherwise invoked and remaining active until clicked or otherwise invoked again. As with traditional button controls, the toggled on state can be denoted using a different appearance or legend text or both.

The slidable-button control can also be dragged in predetermined directions. In this case, a “dead zone” may be implemented so that the slidable-button control does not drag or follow the screen pointer until a predetermined drag distance and/or drag time interval has been achieved. For no “dead zone” the minimum drag distance and/or drag time interval can be said to be zero. While the minimum drag distance and/or drag time interval has not been achieved, the slidable-button control can be said to be anchored to its initial location.

Once the minimum drag distance and/or drag time interval has been reached, the slidable-button control becomes un-anchored and begins to follow the screen pointer, altering a software value as the slidable-button control follows the screen pointer. In this case, there is no additional “dead zone” until the control is released and used again. In one embodiment, the slidable-button control would be bound to a vertical or horizontal path constraint depending on the vertical or horizontal nature of the slidable-button control. In another embodiment, the un-anchored slidable-button control would be free to move in both horizontal and vertical directions, acting as an on-screen joy stick and altering two software values specifying horizontal and vertical position simultaneously.

Once the slidable-button control is un-anchored, computer graphics may optionally be used to morph the appearance of the slidable-button from a button-like appearance to a slider-like appearance. In one embodiment, the morphing appearance would occur as soon as the slidable-button control is un-anchored and may then be restored once the slidable-button control is released.

Once the slidable-button control is un-anchored, computer graphics may be used to denote the allowed direction of motion and extent of motion of the button via slider tracks or the like. In one embodiment, the graphics would appear as soon as the slidable-button control is un-anchored and may then be erased once the slidable-button control is released.

In another embodiment, once the slidable-button control is un-anchored, a display window may appear and be used to display the current value. In one embodiment, this display would appear as soon as the slidable-button control is un-anchored and may then be erased once the slidable-button control is released.

In another embodiment, once the slidable-button control is un-anchored, the current value of the slidable-button control may be displayed as text or graphics within the body of the slidable-button control itself. In this embodiment, the current text or legend of the slidable-button control would be replaced or augmented with the value as soon as the slidable-button control is un-anchored and may then return to the normal legend once the slidable-button control is released.

In another embodiment, once the slidable-button control is un-anchored, the slidable-button function can overlap other elements of the GUI, allowing for tighter integration and placement of GUI elements. Once the slidable-button function is terminated, the GUI would return to its normal appearance without indication of the previously overlapping GUI elements.

The method and system disclosed herein includes a second embodiment of the new composite control that may be referred to as a clickable-slider control. In its normal state, the composite clickable-slider control appears and functions as a slider. The handle of the clickable-slider control can be clicked to function as a momentary control, active only as it is clicked or, in another embodiment, the handle of the clickable-slider control can function as a toggle on/off control, active once clicked or otherwise invoked and remaining active until clicked or otherwise invoked again. As with traditional button controls, the toggled on state can be denoted using a different appearance or legend text or both.

Fulfilling its primary function, the clickable-slider control can also be dragged in predetermined directions. In this case, a “dead zone” may be included so that the clickable-slider control does not drag or follow the screen pointer until a predetermined drag distance and/or drag time interval has been achieved. This aids in discrimination and rejection of unintentional movement during a click operation. For no “dead zone” the minimum drag distance and/or drag time interval can be said to be zero. While the minimum drag distance and/or drag time interval has not been achieved, the clickable-slider control can be said to be anchored to its initial location.

Once the minimum drag distance and/or drag time interval has been reached, the clickable-slider control becomes un-anchored and begins to follow the screen pointer using a typical slider behavior, altering a software value as the clickable-slider control follows the screen pointer. In this case, there is no additional “dead zone” until the control is released and used again, allowing the slider to re-enter the “dead zone” to select a slider position within the “dead zone”. In one embodiment, the clickable-slider control would be bound to a vertical or horizontal path constraint depending on the vertical or horizontal nature of the clickable-slider control. In another embodiment, the un-anchored clickable-slider control would be free to move in both horizontal and vertical directions, acting as an on-screen joy stick and altering two software values specifying horizontal and vertical position simultaneously.

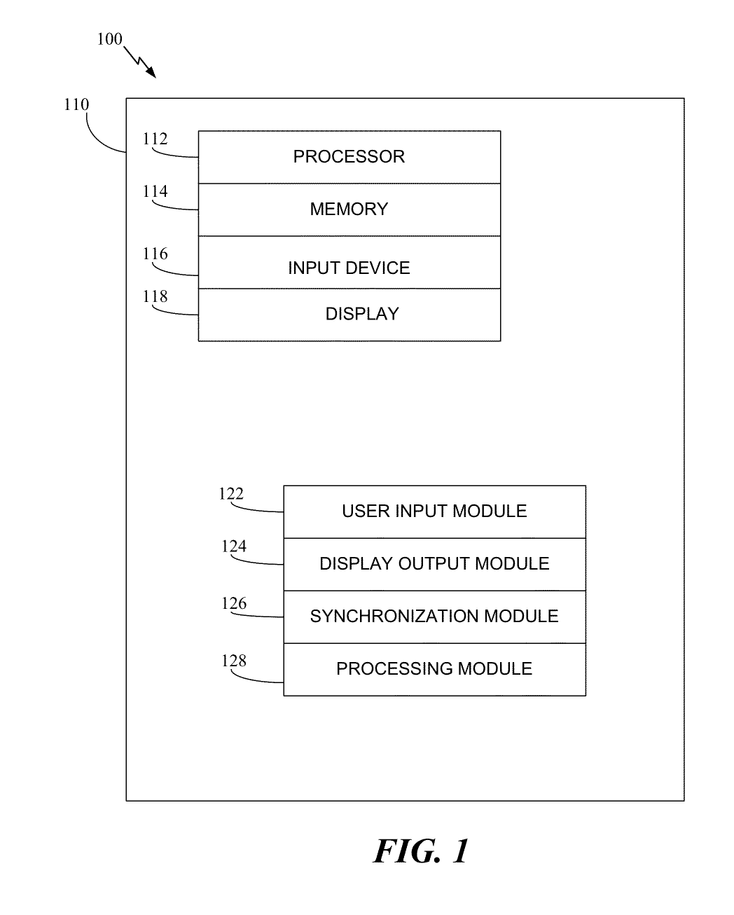

A block diagram of a particular embodiment of a system for combining the functionality of a composite button and slider control is disclosed in FIG. 1 and generally designated 100. The system 100 includes a computing device 110 having at least one processor 112 and a memory 114 that is accessible to the processor 112. The memory 114 includes media that is readable by the processor 112 and that stores data and program instructions of software modules that are executable by the processor 112.

Additionally, the computing device 110 having at least one means of user input 116, either keyboard, mouse, light pen, track ball, track pad, joy stick, graphics tablet, touch screen, or other GUI pointing device or any combination thereof that is accessible to the processor 112.

Additionally, the computing device 110 having at least one means of user display 118, either a cathode ray tube (CRT) display, liquid crystal display (LCD), light emitting diode (LED) display, plasma display, or other GUI display device that is accessible to the processor 112.

Additionally, the processor 112 executes software residing in memory 114 which monitors, processes and reacts to user input from the input device 116 using a user input software module 122, displays screen pointer movements and GUI elements to the output device 118 using a display output software module 124, synchronizes the user pointer input actions to the GUI output actions using a synchronization software module 126, and processing the combined GUI actions using a processing software module 128.

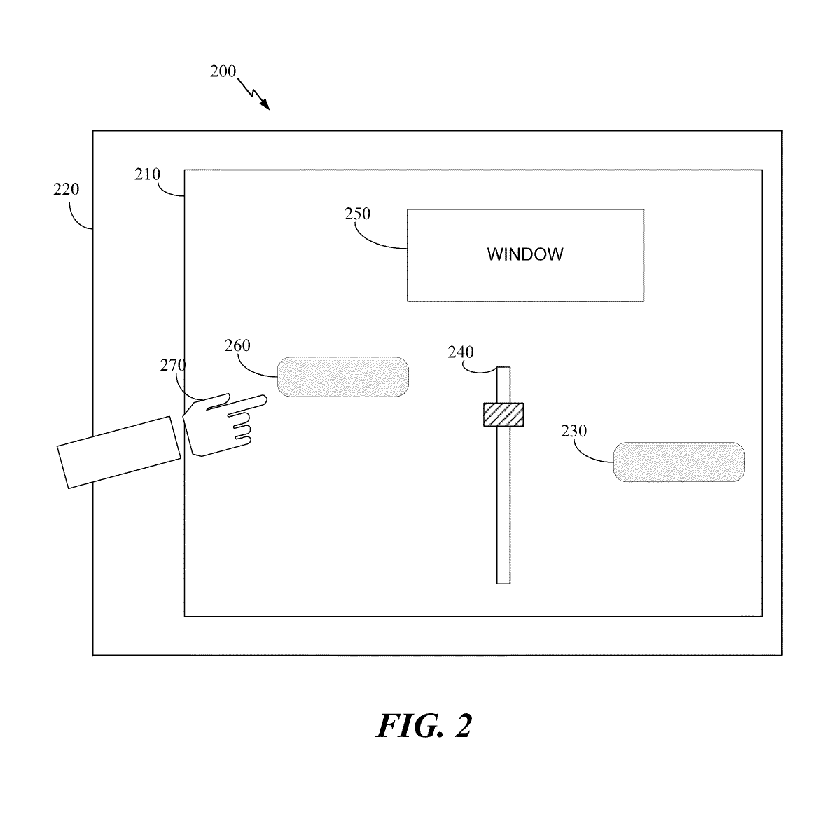

Referring now to FIG. 2, a particular illustrative embodiment of the system is disclosed. The disclosed system is generally designated 200. The disclosed system 200 is comprised of a graphical user interface (“GUI”) 210 that is displayed on the user display hardware 220. The GUI 210 may contain typical GUI control and display elements including but not limited to a typical button 230, typical slider control 240, and window 250. As presently illustrated in FIG. 2, the new slidable-button control 260 is in its button state, being either not accessed by the user, or accessed using single or multiple clicks of the input device 270, in this case an operator's finger using a touch screen display 220.

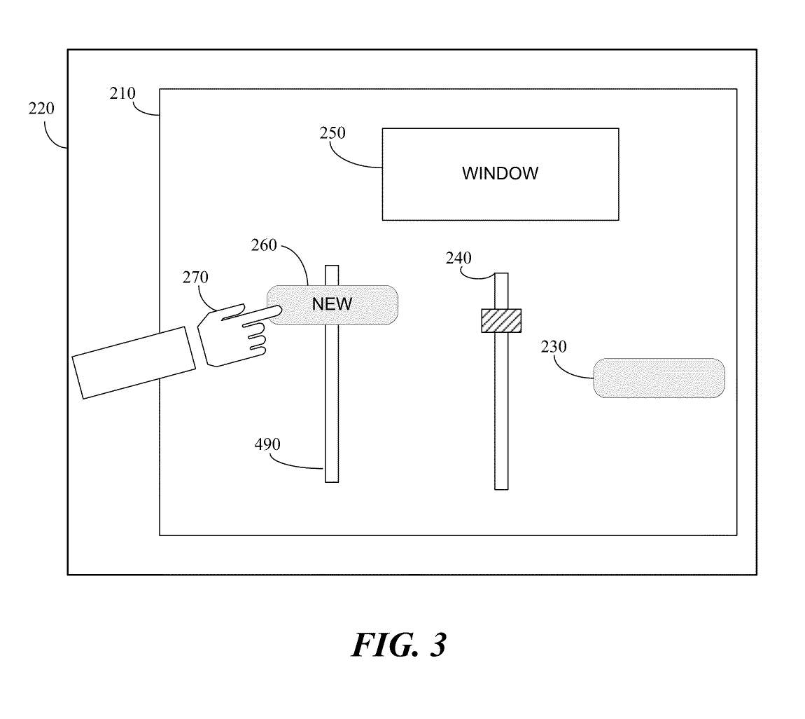

FIG. 3 is a diagram of a particular illustrative embodiment of a GUI incorporating the invention and showing the active, anchored state of the composite slidable-button control 260 that has morphed into a slider control as the pointing device 270 drags the button control 260 for a predetermined distance and/or predetermined amount of time triggering the morphing of the button control 260 to the slider control and slider track 490. The pointing device, or as illustrated in this example, an operator's finger, 270 uses a touch screen display to begin to toggle the button 260.

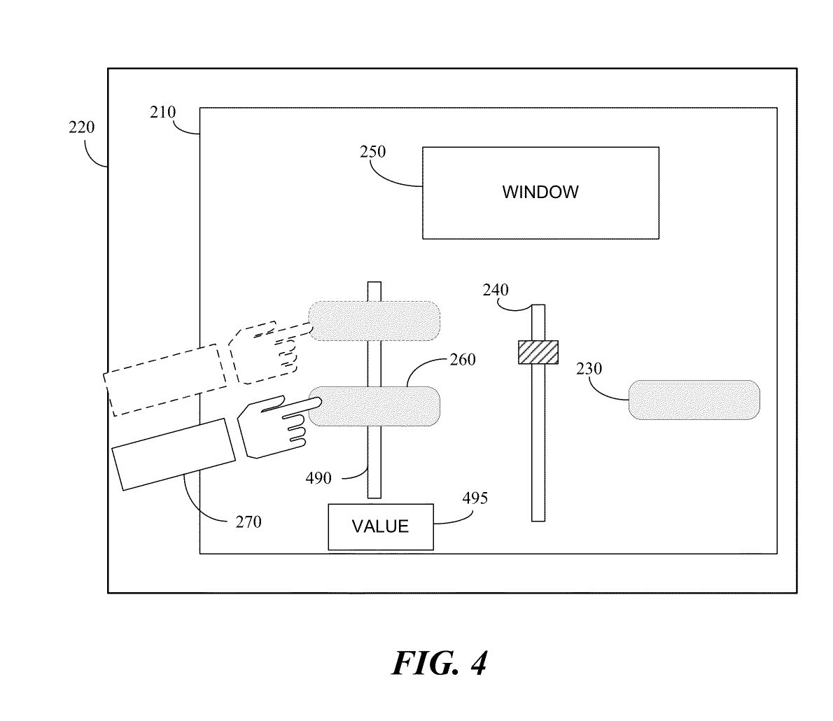

FIG. 4 is a diagram of a particular illustrative embodiment of a GUI incorporating the invention and showing the active, un-anchored state of the morphed composite slidable-button control 260 having been dragged from its original position as the drag distance of the pointing device 270 was equal to or greater than the minimum distance required to un-anchor the slidable-button 260 from its original position. The button 260 will remain in its new position until it is released by the pointing device 270. Once the slidable-button 260 is released, such as an operator's finger 270 is removed from a touch screen monitor, the slidable-button's current software value is recorded 495 and morphs back to its original form as a button control (or element).

In a particular embodiment, computer generated graphics can be used to show the track or extent of the slidable-button's motion once it has become un-anchored, these computer generated graphics would remain displayed as long as the slidable-button 260 is adjusted and then be erased once the slidable-button 260 is released.

In a particular embodiment, a value window 495 can be used to show the current value once the slidable-button 260 becomes un-anchored. This value window 495 would remain displayed as long as the slidable-button 260 is toggled and then be erased once the composite slidable-button 260 is released.

In another embodiment, the value can be displayed inside the slidable-button 260, replacing any existing text while the control is in use.

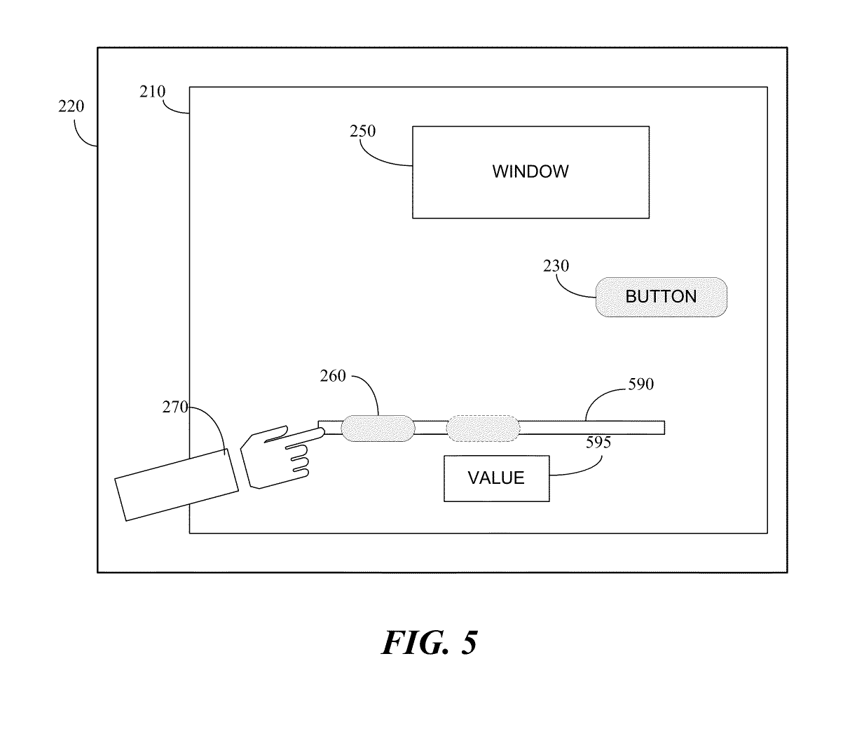

FIG. 5 is a diagram of a particular illustrative embodiment of a GUI incorporating the invention in its clickable-slider configuration and showing the active, un-anchored state of the clickable-slider control 260, particularly when the drag distance is equal to or greater than the minimum distance required to un-anchor the clickable-slider control from its original position. The clickable-slider control 260 is in a horizontal slider configuration. Once the minimum drag distance is met, the clickable-slider 260 will un-anchor from its original position and slide along the slider track 590. Once the clickable-slider 260 is released, such as an operator's finger 270 removed from a touch screen monitor, the slider software value is recorded. Clicking the handle of the clickable-slider control without dragging the control invokes the button nature of the clickable-slider control, which is optionally displayed in the slider handle by altering the text or appearance of the handle.

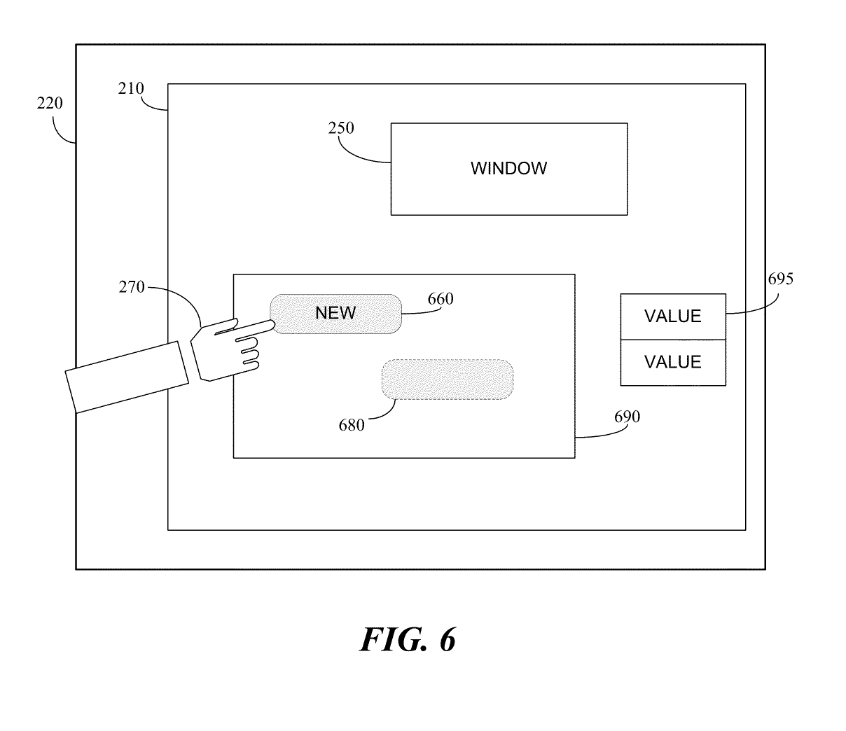

FIG. 6 is a diagram of a particular illustrative embodiment of a GUI incorporating the invention and showing the active, un-anchored state of the slidable-button composite control 660, particularly when the drag distance is equal to or greater than the minimum distance required to un-anchor the slidable-button control from its original position 680. Once the slidable-button control 660 is released, such as an operator's finger 270 removed from a touch screen monitor, the current slider software value is recorded 695 and the slidable-button control 660 returns to its original position 680. In a particular embodiment, computer generated graphics can be used to show the track or extent of the slidable-button 660 motion once the button 660 becomes un-anchored. These computer generated graphics would remain displayed as long as the slidable-button control 660 is adjusted and then be erased once the slidable-button control 660 is released.

In a particular embodiment, one or more value windows 695 can be used to show the current value once the control 660 becomes un-anchored. These value windows 695 would remain displayed as long as the control 660 is adjusted and then be erased once the button control 660 is released.

In another embodiment, one or more values can be displayed inside the control 660, replacing any existing text while the control is in use.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method of implementing a composite control for a graphical user interface, the method comprising:
displaying a slidable button control on a visual display at a first location;
morphing the slidable button control into a slider control in response to a pointing device providing directional instructions to move the slidable button, wherein the slider control includes a slider configured to slide along a slider track;
displaying the slider at a desired location on the slider track in response to the pointing device; and
morphing the slider control back into the slidable button control in response to the pointing device releasing the slider control.

2. The method of claim 1, wherein the response to the pointing device clicking or dragging the composite control is received from a first input of the pointing device.

3. The method of claim 2, wherein the response to the pointing device providing directional instructions to move the slider along the slider track is received from a second input of the pointing device.

4. The method of claim 3, wherein the response to the pointing device providing moving instructions to move the composite control to the new area on the display is received from a third input of the pointing device.

5. The method of claim 4, wherein the pointing device is one of a keyboard, mouse, light pen, track ball, track pad, joy stick, graphics tablet, touch screen, or any combination thereof.

6. The method of claim 5, wherein the composite control does not begin to move to the second location until a predetermined drag distance has been reached.

7. The method of claim 5, wherein the composite control does not begin to move to the second location until a predetermined drag time delay has been reached.

8. The method of claim 6, wherein the slider functions as a toggle on/off control when clicked and remains active until clicked again.

9. A system for a composite control for a graphical user interface, the system comprising:
a slidable button control at a first location on a visual display, wherein the slidable button control configured to morph into a slider control in response to a pointing device providing directional instructions to move the slidable button; and
the slider control comprising a slider configured to slide along a slider track, wherein the slider control morphs back into the slidable button control in response to the pointing device hovering over the slider control.

10. The system of claim 9, wherein the response to the pointing device hovering over the slider control is received from a first input of the pointing device.

11. The system of claim 10, wherein the response to the pointing device providing directional instructions to move the slider along the slider track is received from a second input of the pointing device.

12. The system of claim 11, further comprising a response to the pointing device to move the slider control to a new area on the display is received from a third input of the pointing device.

13. The system of claim 12, wherein the pointing device is one of a keyboard, mouse, light pen, track ball, track pad, joy stick, graphics tablet, touch screen, or any combination thereof.

14. The system of claim 13, wherein the composite control does not begin to move to the second location until a predetermined drag distance has been reached.

15. The method of claim 14, wherein the composite control does not begin to move to the second location until a predetermined drag time delay has been reached.

16. The system of claim 14, wherein the slider functions as a toggle on/off control when clicked and remains active until clicked again.

17. A non-transitory processor readable medium having processor instructions that are executable to cause a processor to:
display a slider control on a visual display at a first location, wherein the slider control includes a slider configured to slide along a slider track and the slider functions as a toggle on/off control when clicked and remains active until clicked again;
morph the slider control into a slidable button element in response to a pointing device hovering over the slider control;
morph the slidable button element back into the slider control in response to the pointing device providing directional instructions to move the slider along the slider track;
display the slider at a desired location on the slider track in response to the pointing device; and
move the slider control to a second location on the visual display in response to the pointing device providing moving instructions to move the slider control to a new area on the display.

18. The non-transitory processor readable medium of claim 17, wherein the response to the pointing device hovering over the slider control is received from a first input of the pointing device.

19. The non-transitory processor readable medium of claim 18, wherein the response to the pointing device providing directional instructions to move the slider along the slider track is received from a second input of the pointing device.

20. The non-transitory processor readable medium of claim 18, wherein the response to the pointing device providing moving instructions to move the slider control to the new area on the display is received from a third input of the pointing device.

21. The non-transitory processor readable medium of claim 20, wherein the pointing device is one of a keyboard, mouse, light pen, track ball, track pad, joy stick, graphics tablet, touch screen, or any combination thereof.

22. The non-transitory processor readable medium of claim 21, wherein the slider control does not begin to move to the second location until a predetermined drag distance has been reached.

23. The non-transitory processor readable medium of claim 21, wherein the slider control does not begin to move to the second location until a predetermined drag time delay has been reached.
